(19) United States
(12) Patent Application Publication
(10) Pub. No.: US 2016/0112783 A1
(43) Pub. Date: Apr. 21, 2016

(54) SPEAKER RETAINER

(71) Applicant: ComHear, Inc., San Diego, CA (US)

(72) Inventor: Sam Aleksandrovich Shifron, Del Mar, CA (US)

(21) Appl. No.: 14/882,545

(22) Filed: Oct. 14, 2015

Related U.S. Application Data
(60) Provisional application No. 62/066,407, filed on Oct. 21, 2014.

(51) Int. Cl. H04R 1/02; H04R 7/16

(52) U.S. Cl. CPC H04R 1/025; H04R 7/16

(57) ABSTRACT

A speaker retainer configured for attachment to a speaker enclosure and further configured for contact with a speaker cone assembly is provided. The speaker cone assembly has a surface area. The speaker retainer includes a circumferential segment extending from an inner circumferential surface to an outer circumferential surface. The circumferential segment has an inner major surface configured for contact with the speaker cone assembly. The inner major surface has a surface area. The surface area of the inner major surface of the circumferential segment forms a ratio with the surface area of the cone assembly in a range of from 10:1 to about 50:1.

### RELATED APPLICATIONS

This application claims the benefit of U.S. Provisional Patent Application No. 62/066,407, filed Oct. 21, 2014, the disclosure of which is incorporated herein by reference in its entirety.

### BACKGROUND

A speaker is a transducer, that is, a device that converts audio signals into corresponding sounds. Speakers can be configured with differing mechanisms to convert the audio signals into the sounds. In one non-limiting example, a speaker can be configured with an electroacoustic transducer. In other non-limiting examples, a speaker can be configured with mechanisms such as piezo transducers and ribbon drivers to convert audio signals into corresponding sounds. Where high fidelity reproduction of sound is required, multiple speakers may be used, each reproducing a part of the audible frequency range.

Typically a speaker is assembled from components including one or more permanent magnets, a voice coil, suspension structures and a diaphragm. The voice coil is a coil of wire suspended in a circular gap between the poles of the one or more permanent magnets. The suspension structures connect the permanent magnets and voice coil with the diaphragm. In certain instances, the one or more permanent magnets, voice coil, suspension structures and diaphragm are positioned within an enclosure or housing.

In operation, application of an alternating current electrical audio signal to the voice coil causes the voice coil to move rapidly back and forth due to Faraday's law of induction. In turn, movement of the voice coil causes the diaphragm to move back and forth, pushing on the air to create sound waves.

It would be advantageous if the sound waves emitted by speakers could be improved.

### SUMMARY

In accordance with embodiments of this invention, there is provided a speaker retainer configured for attachment to a speaker enclosure and further configured for contact with a speaker cone assembly, the speaker cone assembly having a surface area. The speaker retainer includes a circumferential segment extending from an inner circumferential surface to an outer circumferential surface. The circumferential segment has an inner major surface configured for contact with the speaker cone assembly. The inner major surface has a surface area. The surface area of the inner major surface of the circumferential segment forms a ratio with the surface area of the cone assembly in a range of from 10:1 to about 50:1.

In accordance with other embodiments, there is also provided a speaker retainer configured for attachment to a speaker enclosure and further configured for contact with a speaker cone assembly. The speaker cone assembly has a surface area. The speaker retainer includes a circumferential segment extending from an inner circumferential surface to an outer circumferential surface. The circumferential segment has an inner major surface configured for contact with the speaker cone assembly. The inner major surface has a surface area. The surface area of the inner major surface of the circumferential segment occupies about 2.0% to about 10.0% of the surface area of the cone assembly.

In accordance with other embodiments, there is also provided a speaker assembly. The speaker assembly includes a speaker enclosure and a cone assembly positioned within the enclosure. The cone assembly includes a cone and a surround. The surround has a surface area. A speaker retainer is configured for attachment to a speaker enclosure and further configured for contact with the surround. The speaker retainer comprises a circumferential segment extending from an inner circumferential surface to an outer circumferential surface. The circumferential segment has an inner major surface configured for contact with the surround. The inner major surface has a surface area. The surface area of the inner major surface of the circumferential segment forms a ratio with the surface area of the surround in a range of from 10:1 to about 50:1.

Various advantages of the speaker retainer will become apparent to those skilled in the art from the following detailed description, when read in light of the accompanying drawings.

### BRIEF DESCRIPTION OF THE DRAWINGS

FIG. 1 is a perspective, exploded view of a speaker assembly.

FIG. 2 is a perspective view of a cone assembly of the speaker assembly of FIG. 1 and a first embodiment of a speaker retainer.

FIG. 3a is a plan view, in elevation, of a speaker retainer of FIG. 2.

FIG. 3b is a side view, in elevation, of a speaker retainer of FIG. 2.

FIG. 3c is a front view, in elevation, of a speaker retainer of FIG. 2.

FIG. 4 is a front view, in elevation, of a second embodiment of a speaker retainer of FIG. 2.

FIG. 5 is a front view, in elevation, of a third embodiment of a speaker retainer of FIG. 2.

FIG. 6 is a front view, in elevation, of a fourth embodiment of a speaker retainer of FIG. 2.

### DETAILED DESCRIPTION OF THE INVENTION

The speaker retainer will now be described with occasional reference to the specific embodiments. The speaker retainer may, however, be embodied in different forms and should not be construed as limited to the embodiments set forth herein. Rather, these embodiments are provided so that this disclosure will be thorough and complete, and will fully convey the scope of the speaker retainer to those skilled in the art.

Unless otherwise defined, all technical and scientific terms used herein have the same meaning as commonly understood by one of ordinary skill in the art to which the speaker retainer belongs. The terminology used in the description of the speaker retainer herein is for describing particular embodiments only and is not intended to be limiting of the speaker retainer. As used in the description of the speaker retainer and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the speaker retainer. Notwithstanding that the numerical ranges and parameters setting forth the broad scope of the speaker retainer are approximations, the numerical values set forth in the specific examples are reported as precisely as possible. Any numerical values, however, inherently contain certain errors necessarily resulting from error found in their respective measurements.

In accordance with the illustrated embodiments, a speaker retainer is provided. It will be understood the term “speaker assembly”, as used herein, is defined to mean any structure, component or combination thereof, configured to convert audio signals into corresponding sounds.

The description and figures disclose a speaker retainer. Generally, the speaker retainer is a structure used to attach and retain a speaker cone/surround assembly to an enclosure. Since the speaker retainer is in contact with the speaker cone/surround assembly, the structure of the speaker retainer is a factor in determining the quality of the sound waves formed by and emitted from a speaker cone/surround assembly. As will be explained in more detail below, the speaker retainer is structured such as to be “acoustically transparent”, that is, the structure of the speaker retainer is configured to have minimal influence on the sound waves formed by and emitted from speaker cone/surround assembly.

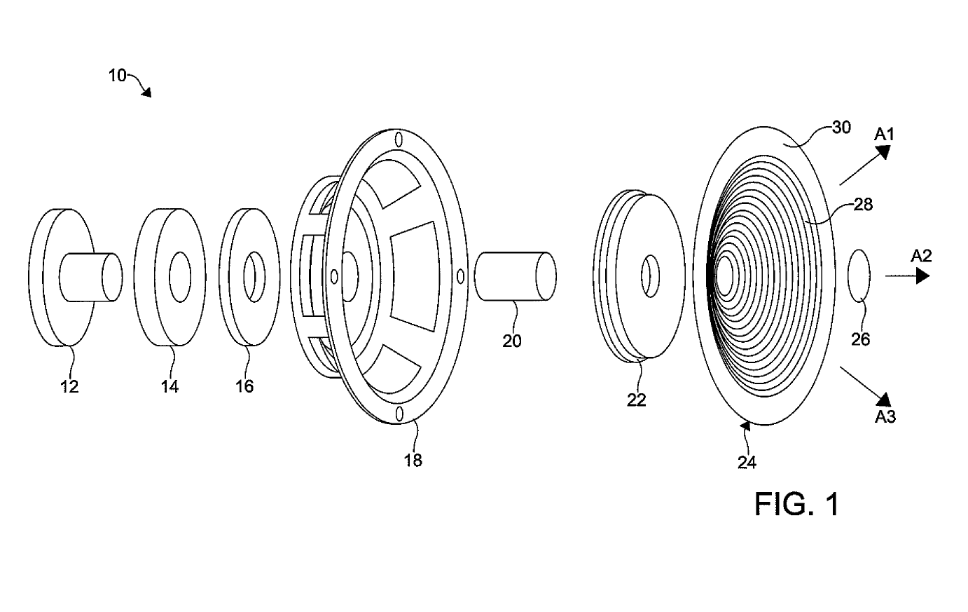

Referring now to the drawings, there is illustrated in FIG. 1 a diagrammatic, simplified and exploded view of one embodiment of a traditional speaker assembly 10. Speaker assemblies are known in the art and will only be briefly described herein. The speaker assembly 10 includes a pole piece 12, one or more magnets 14, a back and top plate assembly 16, an enclosure 18, a voice coil 20, a spider 22, a cone assembly 24 and a dust cap 26.

Referring again to FIG. 1, the pole piece 12 and the back and top plate assembly 16 are magnetically conductive components configured to efficiently concentrate the magnets 14 energy around the voice coil 20. The magnet 14 is configured to provide a non-changing magnetic field that allows the voice coils 20 alternating magnetic force to be attracted or repelled. The voice coil 20 is an electromagnet configured to receive alternating current electrical audio signals. The received signals cause the voice coil 20 to move rapidly back and forth. The back and forth movement of the voice coil 20 causes movement of the cone assembly 24. The spider 22 is configured to maintain the relative positions of the voice coil 22 and the cone assembly 24 and further configured to allow movement of the voice coil 22 and the cone assembly 24. In certain embodiments, the spider 22 is formed from a resilient cloth-based material, although other materials can be used.

Referring again to FIG. 1, the cone assembly 24 includes a cone 28 and a surround 30. The cone 28 is configured for movement as caused by the voice coil 20. Movement of the cone 28 causes movement of air proximate to the cone 28, which in turns forms sound waves that are emitted from cone assembly 24. The surround 30 is configured to maintain the relative position of the cone 28 within the enclosure 18 and further configured to allow movement of the cone 28.

Referring again to FIG. 1, the dust cap 26 is a cover configured to prevent debris from entering gaps between the magnet 14, the pole piece 12 and the voice coil 20. Finally, the enclosure 18 is configured to house the various components forming the speaker assembly 10.

In operation, sound waves produced by the cone 28 as shown schematically by direction arrows A1-A3.

While the speaker assembly 10 includes the components shown in FIG. 1 and described above, in other embodiments, the speaker assembly 10 can have other components and can operate in different manners.

While the speaker assembly 10 shown in FIG. 1 and described above has a substantially circular cross-sectional shape, it should be appreciated that the speaker assembly 10 can have other desired cross-sectional shapes, including the non-limiting examples of an ovular or rectangular cross-sectional shape.

Referring now to FIG. 2, the cone assembly 24 and a speaker retainer are illustrated. The cone assembly 24 includes the cone 28 and the surround 30. Generally, the speaker retainer 40 is a structure used to attach and retain the cone assembly 24 to the enclosure 18 and also configured to retain the relative position of the cone assembly 24 within the enclosure. The speaker retainer 40 includes an inner circumferential surface 42, an outer circumferential surface 44 and a circumferential segment 46 extending therebetween. The circumferential segment 46 includes an outer major surface 48 and an inner major surface 50.

Referring again to FIG. 2, the outer surface 44 of the speaker retainer 40 is configured for attachment to the enclosure 18. In the illustrated embodiment, the outer surface 44 of the speaker retainer 40 is attached to the enclosure 18 through the use of adhesives, although in other embodiments, other structures, devices and mechanisms can be used. In an assembled arrangement, the outer surface 44 abuts the enclosure 18 and the inner major surface 50 of the circumferential segment 46 of the speaker retainer 40 can be in contact with a portion of the surround 30 of the cone assembly 24.

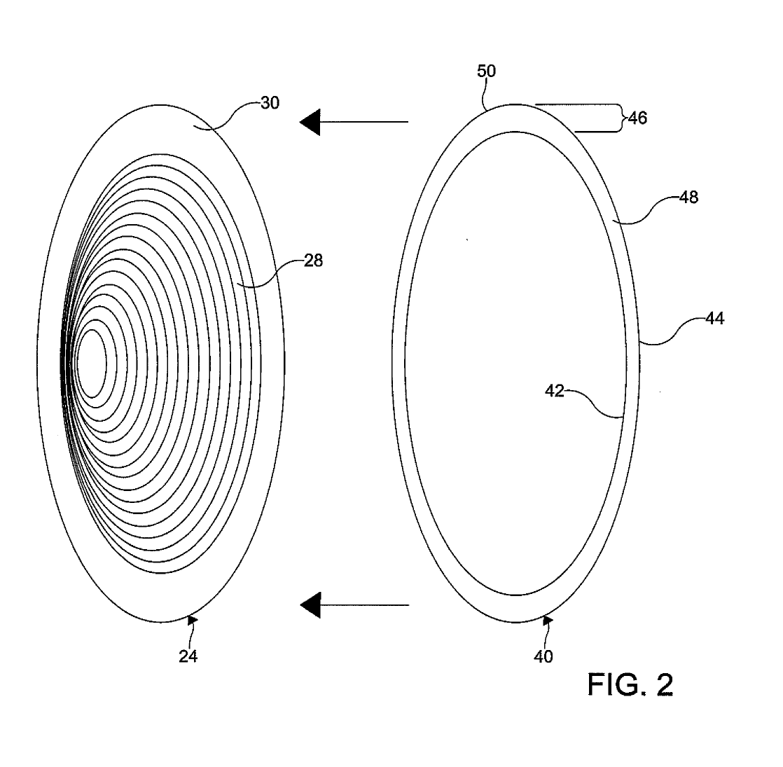

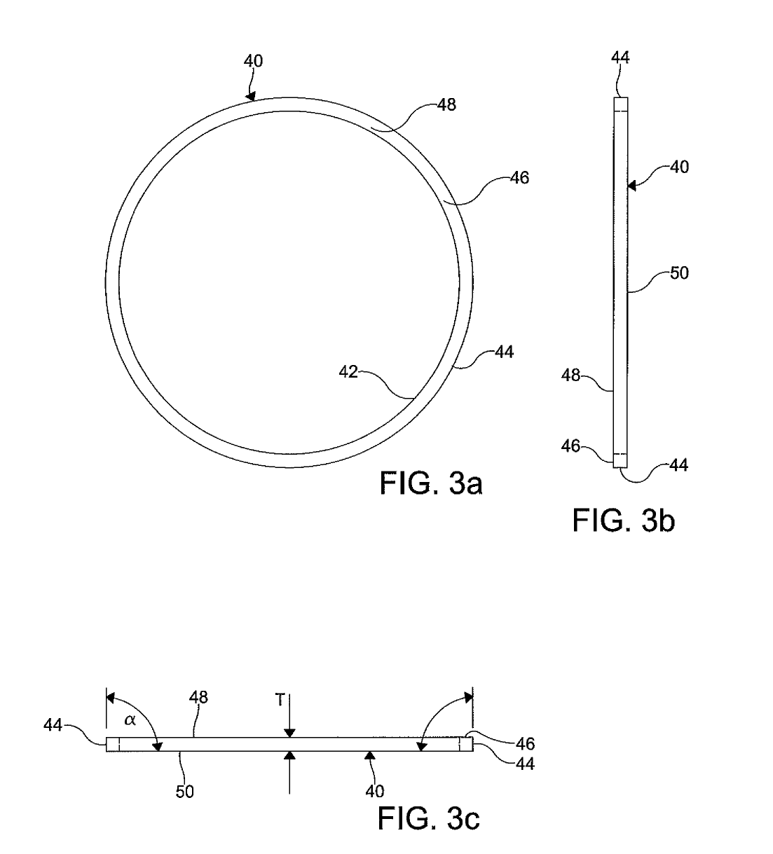

Referring now to FIGS. 3a, 3b and 3c, various views of the speaker retainer 40 are illustrated. The speaker retainer 40 includes the inner circumferential surface 42, the outer circumferential surface 44, the circumferential segment 46, the outer major surface 48 and the inner major surface 50.

The circumferential segment 46 of the speaker retainer 40 forms a surface area. The surface area of the circumferential segment 46 is minimized, that it, the surface area of the circumferential segment 46 is kept to a minimum to minimize the contact area with the cone assembly 24. Without being held to the theory, it is believed a minimal contact area of the circumferential segment 46 with the cone assembly 24 helps the speaker retainer 40 to be substantially “acoustically transparent”. The term “acoustically transparent”, as used herein, is defined to mean having minimal influence on the sound waves formed by and emitted from cone assembly 24.

Referring again to the embodiment illustrated in FIGS. 3a, 3b and 3c, the surface area of the inner major surface 50 of the circumferential segment 46 forms a ratio with the surface area of the cone assembly 24 in a range of from 50:1 to about 10:1. In other words, the surface area of the inner major surface 50 of the circumferential segment 46 occupies about 2.0% to about 10.0% of the surface area of the cone assembly 24. Again without being held to the theory, it is believed this area ration provides an optimum retention capability while being substantially “acoustically transparent”. However, it should be appreciated that in other embodiments, the inner major surface 50 of the circumferential segment 46 can form a ratio with the surface area of the cone assembly 24 in a range less than about 20:1 or more than about 10:1. It should also be appreciated that in other embodiments, the surface area of the inner major surface 50 of the circumferential segment 46 can occupy an area of the cone assembly 24 in an amount less than about 5.0% or more than about 10.0%.

Referring now to FIG. 3c, a cross section of the speaker retainer 40 is illustrated. The speaker retainer 40 has a thickness T. In the illustrated embodiment, the thickness T of the speaker retainer 40 is minimized, that it, the thickness T of the speaker retainer 40 is kept to a minimum to minimize the influence of circumferential segment 32 on the movement of the cone assembly 24. Without being held to the theory, it is believed that minimizing the influence of the circumferential segment 46 of the speaker retainer 40 on the cone assembly 24 helps the speaker retainer 24 to be substantially “acoustically transparent”, thereby having minimal influence on the sound waves formed by and emitted from cone assembly 24.

Referring again to the embodiment illustrated in FIG. 3c, the thickness T of the speaker retainer 40 is in a range of from about 0.002 inches to about 0.006 inches. However, it should be appreciated that in other embodiments, the thickness T of the speaker retainer 40 can be less than about 0.002 inches or more than about 0.006 inches, sufficient to have minimal influence on the sound waves formed by and emitted from the cone assembly 24.

Referring again to FIG. 3c, the outer circumferential surface 44 forms an angle α with the inner major surface 50. In the illustrated embodiment, the angle α is approximately 90°. However, as will be discussed in more detail below, the angle α can be more or less than 90°.

Referring again to the embodiment shown in FIG. 3c, the speaker retainer 22 has a uniform, or consistent, cross-sectional shape. However, it is within the contemplation of the speaker retainer that other cross-sectional shapes can be used in order to lessen the influence of the speaker retainer on the sound waves formed by and emitted from the cone assembly 24.

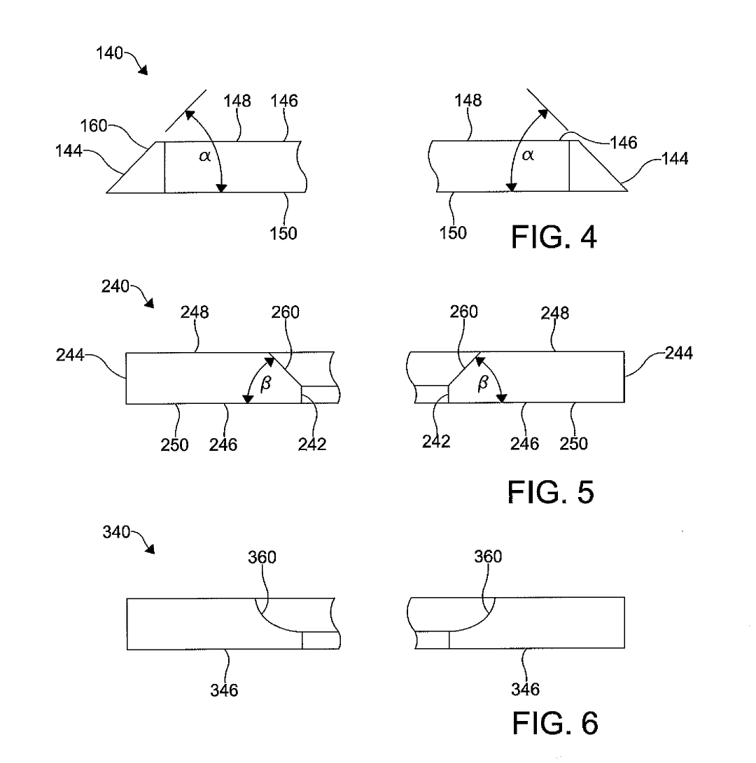

Referring now to FIG. 4, a second embodiment of a speaker retainer 140 is illustrated. The speaker retainer 140 includes an outer major surface 148, an inner major surface 150 and an outer circumferential surface 144. In the illustrated embodiment, the outer major surface 148 and the inner major surface 150 are the same as, or similar to, the outer major surface 48 and the inner major surface 50 illustrated in FIGS. 3a, 3b and 3c and described above. However, in other embodiments, the outer major surface 148 and the inner major surface 150 can be different from the outer major surface 48 and the inner major surface 50.

Referring again to FIG. 4, the outer circumferential surface 144 includes a beveled portion 160. The beveled portion 160 is configured to extend from the inner major surface 150 to the outer major surface 148, thereby further reducing the thickness of a portion of the circumferential segment 146. As discussed above, it is believed reducing the thickness of portions of the circumferential segment 146 helps minimize the influence of the speaker retainer 140 upon the cone assembly 24, thereby helping the speaker retainer 140 to be substantially “acoustically transparent”.

Referring again to FIG. 4, the beveled portion 160 is configured such that the angle α is less than 90°. In the illustrated embodiment, the angle α is in a range of from about 10° to about 80°. However, in other embodiments, the angle α formed by the beveled portion 160 can be less than about 10° or more than about 80°, sufficient that the beveled portion 160 extends from the inner major surface 150 to the outer major surface 148 and reduces the thickness of a portion of the circumferential segment 146.

Referring again to FIG. 4, it is within the contemplation of the speaker enclosure that the beveled portion 160 only extends from either of the outer maj or surface 148 or the inner major surface 150 to the outer circumferential surface 144 and does not extend from the inner major surface 150 to the outer major surface 148.

While the speaker retainer 140 is shown in FIG. 4 as having a beveled outer circumferential surface 144, it should be appreciated that in other embodiments the speaker retainer 140 can have other desired cross-sectional profiles to reduce the thickness of portions of the circumferential segment 146.

Referring now to FIGS. 5 and 6, alternate cross-sectional shapes of speaker retainers are illustrated. The speaker retainer 240 includes an outer major surface 248, an inner major surface 250 and an outer circumferential surface 244. In the illustrated embodiment, the outer major surface 248, inner major surface 250 and the outer circumferential surface 244 are the same as, or similar to, the outer major surface 48, inner major surface 50 and the outer circumferential surface 44 illustrated in FIGS. 3a, 3b and 3c and described above. However, in other embodiments, the outer major surface 248, inner major surface 250 and the outer circumferential surface 244 can be different from the outer major surface 48, inner major surface 50 and the outer circumferential surface 44.

Referring again to FIG. 5, an inner circumferential surface 242 includes a beveled portion 262. The beveled portion 262 is configured to extend from the outer major surface 248 to the inner circumferential surface 242, thereby further reducing the thickness of a portion of the circumferential segment 246. As discussed above, it is believed reducing the thickness of portions of the circumferential segment 246 helps minimize the influence of the speaker retainer 240 upon the cone assembly 24, thereby helping the speaker retainer 240 to be substantially “acoustically transparent”.

Referring again to FIG. 5, the beveled portion 260 is configured such that the angle β is less than 90°. In the illustrated embodiment, the angle β is in a range of from about 10° to about 80°. However, in other embodiments, the angle β formed by the beveled portion 260 can be less than about 10° or more than about 80°, sufficient that the beveled portion 260 extends from the outer major surface 248 to the inner circumferential surface 242 and reduces the thickness of a portion of the circumferential segment 246.

Referring again to FIG. 4, it is within the contemplation of the speaker enclosure that the beveled portion 260 extends from the outer major surface 248 to the inner major surface 250.

Referring now to FIG. 7, a speaker retainer 340 is illustrated. The speaker retainer 340 is the same as, or similar to the speaker retainer 240 illustrated in FIG. 5 with the exception that a beveled portion 360 has an arcuate cross-sectional shape. The arcuate cross-sectional shape of the beveled portion 360 is configured to reduce the thickness of the circumferential segment 346, thereby helping the retainer 340 to be substantially “acoustically transparent”. The beveled portion 360 can have any desired radius or shape, sufficient to reduce the thickness of the circumferential segment 346, thereby helping the retainer 340 to be substantially “acoustically transparent”.

While the embodiments shown in FIGS. 4-6 illustrates either a beveled outer circumferential surface 144 or a beveled inner circumferential surface 242, it should be appreciated that in other embodiments, the speaker retainer can be configured such that both the inner circumferential surface and the outer circumferential surface have beveled cross-sectional shapes, sufficient to help the speaker retainer to be substantially “acoustically transparent”.

Referring again to the embodiments illustrated in FIGS. 3a, 3b, 3c, 4, 5 and 6, the speaker retainers 40, 140, 240 and 340 are formed from materials that assist in the speaker retainer being substantially “acoustically transparent”. Such materials are configured to have minimal influence on the sound waves formed by and emitted from the cone assembly and include the non-limiting examples of polymeric materials, paper materials and coated paper materials.

The principle and mode of operation of the speaker retainer have been described in its illustrated embodiments. However, it should be noted that the speaker retainer may be practiced otherwise than as specifically illustrated and described without departing from its scope.

What is claimed is:

1. A speaker retainer configured for attachment to a speaker enclosure and further configured for contact with a speaker cone assembly, the speaker cone assembly having a surface area, the speaker retainer comprising:
a circumferential segment extending from an inner circumferential surface to an outer circumferential surface, the circumferential segment having an inner major surface configured for contact with the speaker cone assembly, the inner major surface having a surface area;
wherein the surface area of the inner major surface of the circumferential segment forms a ratio with the surface area of the cone assembly in a range of from 10:1 to about 50:1.

2. The speaker retainer of claim 1, wherein the outer circumferential surface and the inner major surface form an angle of about 90°.

3. The speaker retainer of claim 1, wherein the outer circumferential surface and the inner major surface form an angle in a range of about 10° to about 80°.

4. The speaker retainer of claim 1, wherein the speaker retainer has a cross-sectional thickness in a range of from about 0.002 inches to about 0.006 inches.

5. The speaker retainer of claim 1, wherein the inner circumferential surface and the inner major surface form an angle of about 90°.

6. The speaker retainer of claim 1, wherein the inner circumferential surface and the inner major surface form an angle in a range of about 10° to about 80°.

7. The speaker retainer of claim 1, wherein the inner circumferential surface has an arcuate cross-sectional shape.

8. A speaker retainer configured for attachment to a speaker enclosure and further configured for contact with a speaker cone assembly, the speaker cone assembly having a surface area, the speaker retainer comprising:
a circumferential segment extending from an inner circumferential surface to an outer circumferential surface, the circumferential segment having an inner major surface configured for contact with the speaker cone assembly, the inner major surface having a surface area;
wherein the surface area of the inner major surface of the circumferential segment occupies about 2.0% to about 10.0% of the surface area of the cone assembly.

9. The speaker retainer of claim 8, wherein the outer circumferential surface and the inner major surface form an angle of about 90°.

10. The speaker retainer of claim 8, wherein the outer circumferential surface and the inner major surface form an angle in a range of about 10° to about 80°.

11. The speaker retainer of claim 8, wherein the speaker retainer has a cross-sectional thickness in a range of from about 0.002 inches to about 0.006 inches.

12. The speaker retainer of claim 8, wherein the inner circumferential surface and the inner major surface form an angle of about 90°.

13. The speaker retainer of claim 8, wherein the inner circumferential surface and the inner major surface form an angle in a range of about 10° to about 80°.

14. The speaker retainer of claim 8, wherein the inner circumferential surface has an arcuate cross-sectional shape.

15. A speaker assembly comprising:
a speaker enclosure;
a cone assembly positioned within the enclosure, the cone assembly including a cone and a surround, the surround having a surface area;
a speaker retainer configured for attachment to a speaker enclosure and further configured for contact with the surround, the speaker retainer comprising a circumferential segment extending from an inner circumferential surface to an outer circumferential surface, the circumferential segment having an inner major surface configured for contact with the surround, the inner major surface having a surface area;
wherein the surface area of the inner major surface of the circumferential segment forms a ratio with the surface area of the surround in a range of from 10:1 to about 50:1.

16. The speaker assembly of claim 15, wherein the outer circumferential surface and the inner major surface form an angle of about 90°.

17. The speaker assembly of claim 15, wherein the outer circumferential surface and the inner major surface form an angle in a range of about 10° to about 80°.

18. The speaker retainer of claim 15, wherein the speaker retainer has a cross-sectional thickness in a range of from about 0.002 inches to about 0.006 inches.

19. The speaker retainer of claim 15, wherein the inner circumferential surface and the inner major surface form an angle of about 90°.

20. The speaker retainer of claim 15, wherein the inner circumferential surface and the inner major surface form an angle in a range of about 10° to about 80°.
